(19) United States
(12) Patent Application Publication
(10) Pub. No.: US 2013/0027901 A1
(43) Pub. Date: Jan. 31, 2013

(54) METHOD OF ILLUMINATING A MAGNETIC COMPASS OR OTHER TYPE OF INDICIA IN LOW LIGHT SITUATIONS USING PHOTOLUMINESCENT MATERIALS

(71) Applicants: Richard James Martin, Delaplane, VA (US); Herbert George Jones, Elkton, MD (US); Gregory Louis Bender, Alexandria, VA (US)

(72) Inventors: Richard James Martin, Delaplane, VA (US); Herbert George Jones, Elkton, MD (US); Gregory Louis Bender, Alexandria, VA (US)

(73) Assignee: Defense Holdings, Inc., Arlington, VA (US)

(21) Appl. No.: 13/505,180

(22) PCT Filed: Sep. 17, 2010
(86) PCT No.: PCT/US10/49256

§ 371 Date: Oct. 15, 2012

Related U.S. Application Data
(60) Provisional application No. 61/256,891, filed on Oct. 30, 2009.

(51) Int. Cl. F21V 9/16

(52) U.S. Cl. 362/23.01

(57) ABSTRACT

A method for passively illuminating an instrument face and a passively illuminated instrument. The method provides adjacent the instrument face a photoluminescent material encased in a polymer, exposes the photoluminescent material encased in the polymer to an activation source, and illuminates the instrument face by light emitted from the photoluminescent material. A passively illuminated instrument includes a photoluminescent material encased in a polymer and disposed adjacent the instrument face. Upon exposure of the photoluminescent material encased in the polymer to the activation source, the photoluminescent material emits light to illuminate the instrument face.

### CROSS REFERENCE TO RELATED APPLICATIONS

The present application makes reference to the following co-owned applications: 1) U.S. Pat. No. 7,326,435, entitled Low Light Level Illumination for Rotating Objects, issued on Feb. 5, 2008 and 2) U.S. patent application Ser. No. 11/440,097, entitled Photoluminescent (PL) Weapon Sight Illuminator, filed on May 25, 2006. These patents and applications are hereby incorporated by reference in their entirety.

### BACKGROUND OF THE INVENTION

1. Field of the Invention

The present invention relates generally to illumination of a magnetic navigational compass or any similar device using photoluminescent materials as the light source where an indicator or dial must be illuminated during low light conditions. In the case of a magnetic navigational compass, the photoluminescent elements will be used to illuminate the compass face and sighting optic during low light conditions.

2. Discussion of Background

Currently, tritium illuminators consisting of a small transparent containers filled with a quantity of radioactive tritium gas and a photoluminescent materialescent substance such as zinc sulfide are used exclusively as a persistent, non-electric source of illumination in military magnetic hand navigational compasses because of their simplicity and low weight. The tritium gas contained in the illuminators emits ionizing radiation which causes the zinc sulfide to emit visible light. However, tritium presents numerous safety concerns and logistic problems due to its radioactivity and the radioactive half-life of tritium is such that tritium illuminators become dim and must be replaced after about 7 to 10 years. Storage, transportation, disposal and documentation of broken, degraded or damaged tritium sources are expensive and burdensome, resulting in measurable legacy costs.

### SUMMARY OF THE INVENTION

According to one embodiment of the invention, there is provided a method for passively illuminating an instrument face and a passively illuminated instrument. The method provides adjacent the instrument face a photoluminescent material encased in a polymer, exposes the photoluminescent material encased in the polymer to an activation source, and illuminates the instrument face by light emitted from the photoluminescent material.

According to one embodiment of the invention, there is provided a passively illuminated instrument which includes a photoluminescent material encased in a polymer disposed adjacent an instrument face. Upon exposure of the photoluminescent material encased in the polymer to an activation source, the photoluminescent material emits light to illuminate the instrument face.

It is to be understood that both the foregoing general description of the invention and the following detailed description are exemplary, but are not restrictive of the invention.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIG. 1 is a photograph of a photoluminescent disk and photoluminescent rods, according to one embodiment of the invention;

FIG. 2 is a photograph of the installations of a) photoluminescent rods in a compass housing and b) a photoluminescent disk in a compass housing under well-lighted condition;

FIG. 3 is a photograph of the installations shown in FIG. 2 under a low light condition;

FIG. 4 is a graph that depicts luminance as a function of time for one photoluminescent material of the invention;

FIG. 5 is a photograph of an injection molded compass face, according to one embodiment of the invention, using polypropylene to house the photoluminescent material.

### DETAILED DESCRIPTION OF THE INVENTION

According to a first embodiment of the invention, there is provided a method for illuminating a magnetic hand navigational compass face, or any similar device, where indicia (e.g., an indicator or dial) are illuminated during low light conditions by inserting a photoluminescent disk and rod(s) that are passively charged, into the compass housing unit.

According to a second embodiment of the invention, the aforementioned photoluminescent disk and rod(s) include a disk and rod(s) that can be machined, cast, molded, injection molded or formed by other means for example from polypropylene or other polymeric material incorporating photoluminescent pigments into the polymeric material.

According to a third embodiment of the invention, the photoluminescent disk and rod(s) have a circular shape and cylindrical shape respectively. The photoluminescent disk and rod(s) can then be placed on the inside of the housing of the compass or similar device where an indicator or dial is to be illuminated during low light conditions.

In this application for the purpose of elucidating certain aspects of the different embodiments, the term “passively charged” refers to the charging of non-radioactive photoluminescent materials by exposure to natural or artificial light sources (i.e., two examples of am activation source). An example of passively charging a photoluminescent material using natural or artificial light is described below. Moreover, while the invention primarily uses non-radioactive photoluminescent materials in the various embodiments discussed below, radioactive photoluminescent materials (such as for example the tritium described above) could be added to the non-radioactive photoluminescent materials.

In this application for the purpose of elucidating certain aspects of the different embodiments, the term “photoluminescent material” refers to any substance or material exhibiting photoluminescent characteristics. Examples of photoluminescent materials include objects incorporating photoluminescent photoluminescent materials in their physical composition.

In this application for the purpose of elucidating certain aspects of the different embodiments, the term “cast mold” or “injection mold” refers to a method or item manufactured by placing a material into a mold and allowing the item to cure into a desired shape. Exemplary materials that may be placed in the mold include, for example, acrylics or urethanes, such as for example, polypropylene comprising a photoluminescent.

In this application for the purpose of elucidating certain aspects of the different embodiments, the term “alkali earth aluminate” refers to a compound containing aluminum, oxygen, and an alkaline earth metal. Exemplary alkali earth aluminates include, for example, strontium aluminate (e.g., Sr Al₂O₄).

In this application for the purpose of elucidating certain aspects of the different embodiments, the term “alkali earth silicate” refers to a compound containing silicon, oxygen and an alkaline earth metal. Exemplary alkali earth silicates include, for example strontium silicate.

In this application for the purpose of elucidating certain aspects of the different embodiments, the term “alkaline earth metal” refers to an element from Group II of the periodic table. Exemplary alkaline earth metals include beryllium (Be), magnesium (Mg), calcium (Ca), strontium (Sr), barium (Ba) and radium (Ra).

Reference will now be made in detail to the present embodiments of the invention, examples of which are illustrated in the accompanying drawings. Wherever possible, the same reference numbers will be used throughout the drawings to refer to the same or like parts.

In an embodiment of the invention, the photoluminescent material used for the disk and rod(s) may be a passively charged photoluminescent material. This photoluminescent material may be a material including an alkali earth aluminate or an alkali earth silicate. For example, in one embodiment of the invention, an alkali earth aluminate such as strontium aluminate (referred to hereinafter as “SrAl”) may be used. SrAl is a combination of Strontium, Aluminum, and Oxygen. For example, in another embodiment of the invention, the photoluminescent material includes SrAl₂O₄ photoluminescent material crystals. Further, in another embodiment of the invention, the SrAl₂O₄ crystals are doped with rare earth elements, such as, for example, lanthanides (e.g., Europium). Europium doped SrAl₂O₄ emits a green light with a wavelength of approximately 520 nm. In another embodiment of the invention, an alkali earth silicate such as strontium silicate (referred to hereinafter as “SrSi”) that emits a blue light may be used. Similarly, in another embodiment of the invention, SrSi may be doped with rare earth elements, such as, for example, lanthanides (e.g., Europium).

The basic principle behind photoluminescence is as follows: electrons orbiting the photoluminescent material atoms or molecules absorb energy through collision with photons during excitation. The principal excitation source is electromagnetic radiation (i.e., light in the visible and UV wavelengths, with the UV wavelengths being more likely to induce photoluminescence)—absorbed from visible and invisible light parts of the solar spectrum or other light sources. In some applications, it might be desirable to charge the photoluminescent material with a monochromatic light source (e.g., from a light emitting diode or a laser source). The photoluminescent materials can also be excited and induced to emit light as a result of certain types of vibration, heat and friction including for example exposing the photoluminescent materials to body heat and other low temperature sources (i.e., examples of other activation sources). When the excitation source is extinguished, photoluminescent materialescent materials release the stored energy in the form of visible light. It is the released or emitted light, commonly referred to as the afterglow, which is used in different embodiments of the invention as a self-luminous source. The afterglow decreases over time, typically (but not always) exhibiting a hyperbolic decay. The duration and the intensity of the afterglow is a function of several variables including: type of photoluminescent material; intensity of the activation source; type of activation source; and duration of activation exposure. Photoluminescent materials have several advantages over tritium as a source of illumination. These advantages include: photoluminescent materials can be applied easily, they do not require an external power source (i.e., they are a passive system), they are not a hazardous (e.g., non-radioactive), they are reusable and sustainable technology, they are durable and relatively maintenance-free.

As will be discussed in more detail below, the photoluminescent material may in one embodiment of the invention be manufactured using a cast mold technique, such as, for example, by placing a urethane or acrylic including photoluminescent materials (e.g., Strontium Silicate or Strontium Aluminate particles) in a cast mold and allowing the material to cure.

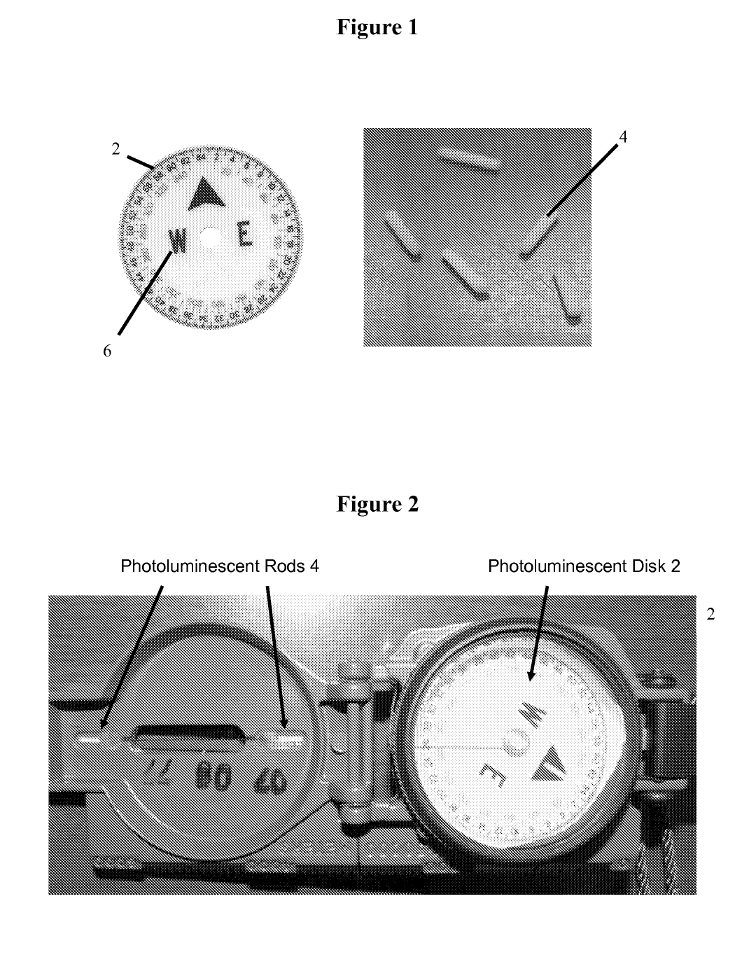

FIG. 1 illustrates a typical molded PL disk 2 and rod(s) 4 associated with this embodiment of the invention. Here, in this embodiment, the molded PL disk 2 has instrumentation indicia 6 printed on the surface of the molded disk 2. The molded disk 4 (shown in FIG. 1 to be a compass face) is one example of a configuration where there is provided a passively illuminated instrument which includes a photoluminescent material encased in a polymer, with the instrument face printed on the polymer encasement 4, and where upon exposure of the photoluminescent material to an activation source, the photoluminescent material emits light to illuminate the instrument face.

In other embodiments, the polymer encasement 4 could be adjacent the instrument face, where the polymer encasement serves as a backlight to the instrument face. In other embodiments, the polymer encasement could be contiguous with the instrument face (as in the integrated or unitary example discussed above), where once again the polymer encasement serves as a backlight to the instrument face.

FIG. 2 shows a photograph of one embodiment of the invention where a magnetic compass with an injection molded polypropylene photoluminescent disk and rod(s) (associated with the invention) installed. In the one embodiment of the invention, the photoluminescent rods are used to illuminate a sighting reference or a cursor on the sighting optic which is used to align the compass housing with objects or features in the environment.

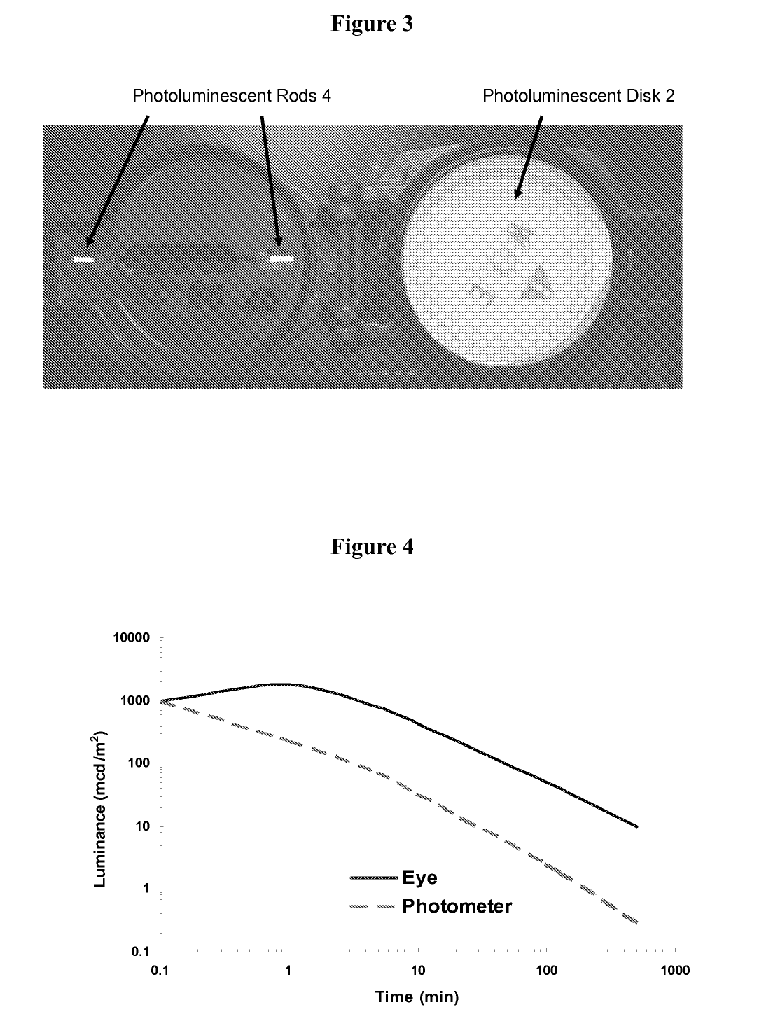

FIG. 3 is a photograph of the installations shown in FIG. 2 under a low light condition. Passive illumination of the magnetic compass permits a person using the compass in low light conditions such as, but not limited to, night, to see accurately both the compass disk and the cursor on the sighting optic. Passive lighting obviates the need for an electrical power source such as batteries and allows the user to be able to use the compass for a long period of time (days, weeks, years) without need for radioactive illuminators or replacement batteries so long as the compass is periodically exposed to higher levels of light from the sun or a variety of other sources (sun, room lighting, flashlights, vehicle lights, etc.).

Other areas of application for the principles delineated in this invention include, but are not limited to, (1) boat, ship, aircraft and/or vehicle compasses, (2) dashboard, cockpit or control station instrument used for control or monitoring where an embodiment of this invention could be used as primary or secondary (back-up) illumination for instrument faces, dials, controls and/or other purposes to communicate or quantify operation, position, or orientation of an item or process being monitored or to control those items or purposes. In this embodiment, the photoluminescent material may be changed by (1) ambient light, (2) if used as a secondary lighting source, by the primary lighting source, or (3) by any other source of natural or artificial lighting of the appropriate wavelength and intensity.

Thus, in one embodiment of the invention, there is provided a system for back-up illumination of instrument faces. In this embodiment, the photoluminescent materials represent lighting elements that are always “charged” during the normal powered illumination of the instrument face (as for example through front light or back light illumination). Upon power interruption, the photoluminescent materials provide immediate illumination of the instrument faces, regardless of how long it takes for the primary power or the back-up power system to re-energize the front lights or back lights. The system includes a primary light source configured to illuminate the instrument face, and includes a photoluminescent material encased in a polymer and disposed adjacent the instrument face. Upon exposure of the photoluminescent material to the primary light source, the photoluminescent material emits light to illuminate the instrument face and maintains illumination upon interruption of the primary light source.

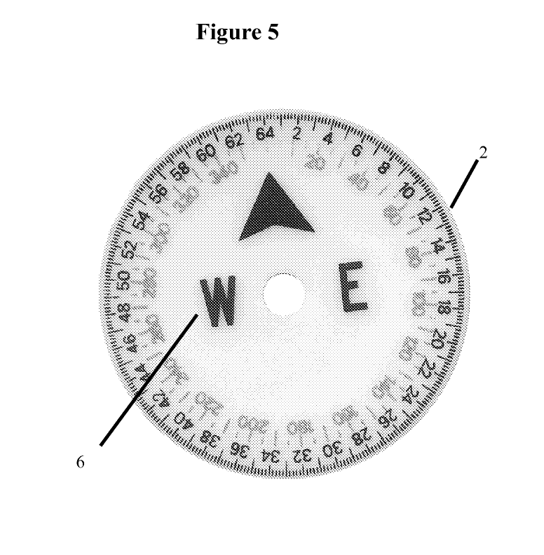

A cast mold or injection molding technique may be used in one embodiment of the invention. For example, a polypropylene, urethane or acrylic material including photoluminescent photoluminescent material crystals (e.g., SrAl particles) may be mixed and placed into a mold where it is allowed to cure. In such an example, the resulting molded disk or rod(s) may be, for example, in the shape of a circle and small cylinder respectively. Thus, when removed from the mold, the resulting disk and rod(s) will accordingly have photoluminescent characteristics. FIG. 5 is a photograph of an injection molded compass face, according to one embodiment of the invention, using polypropylene to house the photoluminescent material.

According to the method, the photoluminescent elements are molded from a mixture of polypropylene and photoluminescent pigment. The strontium aluminate photoluminescent pigment makes up at least thirty-five percent (35%) of the mixture by weight. A mixture of between about forty-five percent and fifty percent (45-50%) of strontium aluminum oxide by weight combined with a very small percentage (between 0.2 to 0.3 percent (0.2-0.3%) by weight) of a UV stabilizer constitute a suitable materials from which to create the photoluminescent component or elements. A suitable stabilizer may be drawn from a known class of compounds such as benzophenones, benzotriazoles, or HALS among others that are known to protect olefins and engineered polymers against damage from UV light.

This mixture has been found to be difficult to compound because of the difficulty of avoiding contamination of the mixture because of the abrasive characteristics of the strontium aluminate photoluminescent materials, especially at high loadings, which tends to abrade the molding machinery (barrel, screw and mold) and contaminate the mixture and limit the materials ability to produce an afterglow. These deleterious effects may be minimized by carefully cleaning the molding machinery and by proper formulation and compounding the material to be molded. The raw materials are thoroughly mixed to produce a uniform molding compound.

The mixture to be molded can be injected in exemplary embodiment of the invention at a pressure between 600 and 700 pounds force per square inch (psi) and held for about thirty (30) seconds at a temperature between 375 degrees Fahrenheit (190° C.) and 400 degrees Fahrenheit (205° C.). Larger than normal gates are required. The molding process can be monitored for better control as the temperature tolerances are relatively tight to allow the materials to flow freely without necessarily producing striations that would limit the transmissibility of light from the item.

In other words, such a cast mold or injection molded technique may be used to manufacture a photoluminescent device. For example, a cast or injection mold technique, such as presently described, may be used to manufacture a shape with photoluminescent characteristics that may be installed into a magnetic compass for the purpose of navigating for example in a low light situation.

It should be noted that these cast mold or injection molded techniques for forming items with photoluminescent characteristics are but exemplary, and other techniques and materials may be used without departing from the invention.

In one embodiment of the invention, the photoluminescent photoluminescent materials, such as for example, alkaline earth aluminate photoluminescent materials, zinc sulfides, such as ZnS:Cu, silicate aluminates, strontium aluminate (SrAlO3:Eu), or combinations thereof are included in a luminescent pigment for spray or coating applications. Various particle sizes, mesh sizes and grades of the pigments may be used depending on the desired effect. Sizes ranging from 10-70 μm particle size and 200 to 500 mesh size, for example, can be employed. The larger the particle size, typically the higher the intensity of luminescence. Particle sizes of about 45-65 μm, 200 mesh, are generally suitable for brush painting and dipping. Particle sizes of about 10-40 μm, 300-400 mesh, are generally suitable for spray painting and plastic molding. Afterglow time and intensity are generally dependent on type of pigment, particle size and grade. Alkaline earth aluminate photoluminescent materials and alkaline earth silicate aluminates have longer afterglow times than ZnS:Cu, for example. The pigment may be added to the media in an amount effective to produce a luminescent effect. Color dyes may also be added to the pigments to achieve various luminescent colors.

The luminescent pigments may be applied in a variety of ways. Paints or coatings may be dipped, brushed, rolled or sprayed onto the markers, for example. Glazes may be applied by painting, pouring or firing, for example. Polymer materials added with the luminescent pigment may include plastic or rubber materials such as, for example, rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, or combinations thereof. In addition to the polymer material and luminescent material, the photoluminescent element may also include silicone (a releasing agent), mineral oil (to improve injection molding flow and/or adhesion to other additives, for example), a foaming agent or filler, dyes or coloring agents, polymerization catalysts, UV stabilizers, cure accelerators, and leveling agents, for example.

In another embodiment of the invention, screen printing or roller coating can be used to apply the photoluminescent material of the invention. For example, a paste can be made of cyano resin or fluororubber dissolved in organic solvent. Photoluminescent material particles can be dispersed in the paste. The paste can be printed by a screen printing. Finally, the paste is dried and formed. By the roller coating, the photoluminescent photoluminescent materials can be dispersed uniformly or substantially uniformly across the whole surface of a substrate. In screen printing, the photoluminescent photoluminescent materials are applied through a specific pattern for example formed in knitting stainless thread sheets or polyester thread sheets of diameter approximately 30 μm. The sheets have opening-sections into which the paste penetrates and closed-sections into which paste does not penetrate, so that a pattern can be printed. A mean diameter of photoluminescent material particles can then be sized for example to be approximately 20 μm to 50 μm to prevent or reduce the transfer of the photoluminescent photoluminescent materials through the closed-sections.

FIG. 4 shows a typical decay curve for the photoluminescent material illustrates the different of “perceived” brightness by the human eye from what a light meter measures. A typical, well-designed SrAl materials can be fully charged from exposure to approximately 3-4 minutes of a typical UV lamp (blacklight) or may be fully charged by approximately 7-8 minutes exposure to bright sunlight. Alternately, it may be fully charged by approximately 21-23 minutes exposure in a room brightly illuminated by fluorescent lighting or following approximately 24-26 minutes exposure in a room brightly illuminated by incandescent lighting.

After being fully charged (for example by exposure to an unfiltered continuous short arc xenon source of light of 500 W or less for 5 min, providing an illumination of 1,000 lux (93 fc) on the marking surface), the SrAl material's curve is above the minimum luminance level for human visibility (0.05 millicandela per square meter (mcd/m²))

All documents, patents, journal articles and other materials cited in the present application are hereby incorporated by reference in their entirety.

Numerous modifications and variations of the invention are possible in light of the above teachings. It is therefore to be understood that within the scope of the appended claims, the invention may be practiced otherwise than as specifically described herein.

1. A method for passively illuminating an instrument face of an instrument, comprising:
providing adjacent the instrument face a photoluminescent material encased in a polymer;
exposing the photoluminescent material encased in the polymer to an activation source; and
illuminating the instrument face by light emitted from the photoluminescent material.

2. The method of claim 1, wherein the providing step comprises providing the photoluminescent material selected from the group consisting of at least one of an alkali earth aluminate, an alkali earth silicate, zinc sulfides, alkaline earth silicate aluminates, strontium aluminate, and combinations thereof.

3. The method of claim 1, wherein the providing step comprises providing the photoluminescent material encased in a polymer selected from the group consisting of rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, and combinations thereof.

4. The method of claim 1, wherein providing the photoluminescent material comprises providing the photoluminescent material encased in the polymer shaped as a sheet, a coating, a rod, a screen print formed article, a machined article, a cast article, an extruded article, a molded article, an injection molded article, an article formed through stereolithography, or a part formed from a rapid fabrication technique.

5. The method of claim 1, wherein providing the photoluminescent material comprises providing the photoluminescent material encased in the polymer in a rod inserted into a housing for the instrument face,
wherein light from the rod in the housing illuminates the instrument face or the illuminated rod provides illumination marks denoting the instrument.

6. The method of claim 1, wherein illuminating the instrument face comprises illuminating at least one of a magnetic hand navigational compass face, a sighting optic, an indicator needle, an instrument face, a dial face, a moving indicator or tape, a control actuator, a feedback indicator, a position indicator, an orientation indicator, a level indicator, or other indicia.

7. The method of claim 1, wherein illuminating the instrument face comprises illuminating the instrument face with blue light, green light, yellow light or a mixture thereof from one or more photoluminescent emitters.

8. The method of claim 1, wherein illuminating the instrument face comprises illuminating the instrument face with an intensity which is between than 0.05 and 100 millicandela per square meter (mcd/m²).

9. The method of claim 1, wherein providing the photoluminescent material comprises providing the polymer, including the photoluminescent material, contiguous with the instrument face, the instrument face having instrumentation indicia printed thereon.

10. The method of claim 1, wherein exposing the photoluminescent material comprises directing at least one of monochromatic or polychromatic light to the photoluminescent material encased in the polymer.

11. A passively illuminated instrument comprising:
an instrument face;
a photoluminescent material encased in a polymer and disposed adjacent the instrument face,
wherein, upon exposure of the photoluminescent material to an activation source, the photoluminescent material emits light to illuminate the instrument face.

12. The device of claim 11, wherein the photoluminescent material comprises a photoluminescent material selected from the group consisting of an alkali earth aluminate, an alkali earth silicate, zinc sulfides, alkaline earth silicate aluminates, strontium aluminate, and combinations thereof.

13. The device of claim 11, wherein the polymer comprises a polymer selected from the group consisting of rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, and combinations thereof.

14. The device of claim 11, wherein the photoluminescent material encased in the polymer comprises a sheet, a coating, a rod, a screen print formed article, a machined article, a cast article, an extruded article, a molded article, an injection molded article, an article formed through stereolithography, or a part formed from a rapid fabrication technique.

15. The device of claim 11, wherein
the photoluminescent material encased in the polymer comprises a rod inserted into a housing for the instrument face, and
light from the rod in the housing illuminates the instrument face or the illuminated rod provides illumination marks denoting the instrument.

16. The device of claim 11, wherein the instrument face comprises at least one of a magnetic hand navigational compass face, a sighting optic, an indicator needle, an instrument face, a dial face, a moving indicator or tape, a control actuator, a feedback indicator, a position indicator, an orientation indicator, a level indicator, or other indicia.

17. The device of claim 11, wherein the photoluminescent material comprises plural photoluminescent emitters which emit blue light, green light, yellow light, or a mixture thereof.

18. The device of claim 11, wherein the photoluminescent material encased in the polymer is configured to emit light through the instrument face at an intensity which is between than 0.05 and 100 millicandela per square meter (mcd/m²).

19. The device of claim 11, wherein
the polymer, including the photoluminescent material, is contiguous with the instrument face, and
the instrument face has instrumentation indicia printed thereon.

20. The device of claim 11, wherein the photoluminescent material encased in the polymer is configured to be exposed to at least one of monochromatic or polychromatic light.

21. A system for back-up illumination of an instrument face of an instrument, comprising:
a primary light source configured to illuminate the instrument face;
a photoluminescent material encased in a polymer and disposed adjacent the instrument face,
wherein, upon exposure of the photoluminescent material to the primary light source, the photoluminescent material emits light to illuminate the instrument face and maintains illumination upon interruption of the primary light source.

22. The system of claim 21, wherein the photoluminescent material comprises a photoluminescent material selected from the group consisting of an alkali earth aluminate, an alkali earth silicate, zinc sulfides, alkaline earth silicate aluminates, strontium aluminate, and combinations thereof.

23. The system of claim 21, wherein the polymer comprises a polymer selected from the group consisting of rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, and combinations thereof.

24. The system of claim 21, wherein the photoluminescent material encased in the polymer comprises a sheet, a coating, a rod, a screen print formed article, a machined article, a cast article, an extruded article, a molded article, an injection molded article, an article formed through stereolithography, or a part formed from a rapid fabrication technique.

25. The system of claim 21, wherein
the photoluminescent material encased in the polymer comprises a rod inserted into a housing for the instrument face, and
light from the rod in the housing illuminates the instrument face or the illuminated rod provides illumination marks denoting the instrument.

26. The system of claim 21, wherein the instrument face comprises at least one of a magnetic hand navigational compass face, a sighting optic, an indicator needle, an instrument face, a dial face, a moving indicator or tape, a control actuator, a feedback indicator, a position indicator, an orientation indicator, a level indicator, or other indicia.

27. The system of claim 21, wherein the photoluminescent material comprises plural photoluminescent emitters which emit blue light, green light, yellow light, or a mixture thereof.

28. The system of claim 21, wherein the photoluminescent material encased in the polymer is configured to emit light through the instrument face at an intensity which is between than 0.05 and 100 millicandela per square meter (mcd/m²).

29. The system of claim 21, wherein
the polymer, including the photoluminescent material, is contiguous with the instrument face, and
the instrument face has instrumentation indicia printed thereon.

30. The system of claim 21, wherein the photoluminescent material encased in the polymer is configured to be exposed to at least one of monochromatic or polychromatic light.
